(19) United States
(12) Patent Application Publication
(10) Pub. No.: US 2015/0124072 A1
(43) Pub. Date: May 7, 2015

(54) SYSTEM AND METHOD FOR COLOR CORRECTION OF A MICROSCOPE IMAGE

(71) Applicant: DATACOLOR, INC., Lawrenceville, NJ (US)

(72) Inventors: Hong Wei, Princeton, NJ (US); Mark S. McNulty, Rlngoes, NJ (US); Michael H. Brill, Kingston, NJ (US)

(73) Assignee: DATACOLOR, INC., Lawrenceville, NJ (US)

(21) Appl. No.: 14/069,835

(22) Filed: Nov. 1, 2013

(51) Int. Cl. H04N 17/00; H04N 9/73

(52) U.S. Cl. CPC H04N 17/002; H04N 9/735
USPC 348/79

(57) ABSTRACT

A system and method for correcting the color of microscope images is described wherein a microscope, equipped with a variable light source and at least one microscope setting selector operates in conjunction with an image recording device having at least one image setting selector with a plurality of settings, and is configured to record at least one white balanced sample image of a sample. The system and method also includes the use of at least one white balanced calibration image of an integral transmissive color filter array of known transmission values in combination with an image processor executing code in order to color calibrate the sample images based on the calibration image.

### THE INVENTION

The present invention describes a system and method for the calibration of microscope slides. The described system allows for images of a sample slide to be calibrated with a calibration slide image taken of a calibration slide. The system and method described allow for faster measurement, greater measurement repeatability and more precise calibration of images taken of microscope slides.

### BACKGROUND OF THE INVENTION

Currently, digital imaging has allowed for unprecedented levels of collaboration between technicians, researchers and scientists. In part, this collaboration is due to the relatively inexpensive nature of current digital imaging technology. Image capture devices and associated software platforms combined with improved computer screens and monitors have also allowed for the rapid analysis and review of images where accurate color fidelity is essential. The proliferation of different styles, models and technical complexity of digital imaging technology can be readily seen in the digital microscopy market. In the field of digital imaging, there are many microscope systems that provide custom digital images. Currently, present systems and methods for generating color calibrated images are inefficient and allow for variations in performance based on operator usage.

Additionally, recording images of hard-to-detail specimens requires diligence. A fortuitous imaging of a sample might not be replicable under subsequent conditions. However, once the image is recorded, modifying it in image editing suites can alter the desired appearance. Therefore, what is needed is the ability to calibrate an image of a sample so that the color on the images are closer to the color seen through the microscope eyepieces and are consistent among varieties of microscope/camera systems.

Co-owned U.S. patent application Ser. No. 13/211,875 titled “System and Apparatus for the Calibration and Management of Color in Microscope Slides” filed on Aug. 17, 2011, herein incorporated by reference in its entirety, describes the use of color calibrated slides to determine the color values of biological samples under various lighting conditions. Likewise, U.S. patent application Ser. No. 13/594,107 titled “System and Apparatus for Color Correction in Transmission-microscope Slides.” filed on Aug. 24, 2012, herein incorporated by reference in its entirety, describes a calibration and evaluation system of images of slides but does not describe the invention provided herein. Furthermore, U.S. patent application Ser. No. 13/856,727 titled “System and Method for Color Correction of a Microscope Image with a Built-in Calibration Slide,” filed Apr. 4, 2012, herein incorporated by reference in its entirety, describes a calibration system, but does not describe the present invention.

The prior art work flow systems require the inclusion of several inefficient and potentially error inducing steps and procedures that may generally diminish the overall quality of the image being taken.

The prior art provides that a user wishing to calibrate images for use in a color calibration system, must first calibrate the microscope with a calibration slide. This entails setting the calibration slide with the microscope or camera settings and obtaining an image. Then, the user is free to obtain an image of the sample desired.

Importantly, the work flow of the prior art requires that the microscope settings be maintained between imaging sessions of the calibration slide and the specimen in order to obtain the optimal color calibration. However, instances occur where the microscopist seeks to change the settings on the microscope after a calibration slide image has already been obtained. As a result, if the microscopist aims to change or alter the settings of the microscope, a new calibration slide image needs to be taken. This procedure is then repeated every time the microscopist wishes to make changes to the microscope. This results in a tedious and repetitive workflow in order to obtain the necessary calibration slide images for use in color calibration. Those skilled in the art will appreciate that changes to the microscope and camera settings are not preformed until after the image of the color calibration slide is taken, because the color calibration algorithm provides optimal calibration values when the images of the calibration slide and the specimen are captured under the same microscope and camera settings.

Therefore, what is needed is a system and method that provides a more efficient and practical work flow which minimizes the amount of additional calibration slide images that a microscopist needs to obtain in order to obtain a useful color calibration of the sample image. In particular, the present system and method provides the user with the capability to obtain the optimal sample image prior to obtaining the proper calibration slide image. Furthermore, the system and method provide a more convenient color calibration system which allows the user to first capture a white balanced image of the sample slide prior to obtaining a calibration slide image under different microscope settings. The system and method described also allows for the acquisition of calibration slide image at any time during the microscope session.

After the user has obtained the desired sample image at the desired microscope and camera configuration, then the user can obtain a calibration slide image for use in generating the color calibration factors. This calibration matrix is used to generate a calibrated, composite image of the sample.

### SUMMARY OF THE INVENTION

A system and method are described for calibrating the color values of microscope images using a microscope, an imaging device and a calibration slide. The invention as described details the use of a microscope and imaging device, with the microscope having at least one microscope setting selector used to obtain an image of a sample, (e.g. configurable objective magnification settings or positions and configurable light intensity selections). In one arrangement of the system and method described, the image device is also equipped with a setting selector. In a further arrangement, a value corresponding to the microscope setting selector and the imaging device setting selector are stored in a database for future use by the system. The system and method are configured to obtain images of both the sample and the calibration slide. The system and method described allows for the acquisition of calibration slide image at any time during the microscope session.

In an alternative arrangement of the image-calibration workflow system and method, the stored microscope and image setting configurations and setting data are used to configure the microscope and imaging device for recording an image of the calibration slide at the same configuration as a previously obtained sample image.

In one alternative arrangement, all of the sample images are taken prior to obtaining an image of the calibration slide. After the sample slides images have been recorded, a separate series of images of the calibration slide is recorded. This series of calibration slide images includes at least one image of the calibration slide at each setting that a sample image was taken. In a further arrangement, the system and method described is configured to automatically configure the microscope and imaging device to take images of the calibration slide based on the status and configuration of the microscope and imaging device at the time the sample images were recorded. In one arrangement, the images of the samples and the calibration slide are white balanced prior to the generation of a color calibration factors.

Additionally, the described image-calibration workflow system and method provide an image calibration appliance component which is configured to extract color value information from the images so as to output a composite image wherein the color values of each pixel have been transformed based on the calibration values. In particular, the color value information extracted from the images and calibrated includes color values that have been white balanced.

### BRIEF DESCRIPTION OF THE DRAWINGS

The foregoing and other features described herein will be more readily apparent from the following detailed description and drawings of illustrative embodiments in which:

FIG. 1 is an illustrative diagram of the microscope system described herein.

FIG. 2 is an illustrative diagram of the calibration slide.

FIG. 3 is an illustrative diagram of components of an automatic calibration system.

FIG. 4 is an illustrated flow chart of the operation of image recording and processing steps.

FIG. 5 is an illustrated flow chart of the operation of the image recording and processing steps.

FIG. 6 is a diagram of a computer system of the present invention.

FIG. 7 is an image of a specimen sample before white balancing according to an embodiment of the present invention.

FIG. 8 are images of a specimen sample after white balancing according an embodiment of the present invention.

FIG. 9 is an illustrated flow chart of the image processing steps of an alternative embodiment of the present invention.

FIG. 10 is an illustrated flow chart of the image processing steps of an alternative embodiment of the present invention.

FIG. 11 is an illustrated flow chart of the image processing steps of an alternative embodiment of the present invention.

### DESCRIPTION OF ILLUSTRATIVE EMBODIMENTS OF THE INVENTION

By way of overview and introduction, the present invention concerns a system and method for obtaining calibrated sample images from a microscope and imaging device. The image-calibration workflow so described allows a user to more quickly acquire images at multiple microscope settings and calibrate those images based on color values obtained from a calibration slide image.

The image-calibration workflow system and method is further directed to introducing a calibration slide to a microscope to obtain a color calibration matrix for use in the calibration of the color values found in images of samples taken under a given microscope configuration and image device configuration. The system and method further calculate a calibrated image of the sample image based on the derived color calibration matrix.

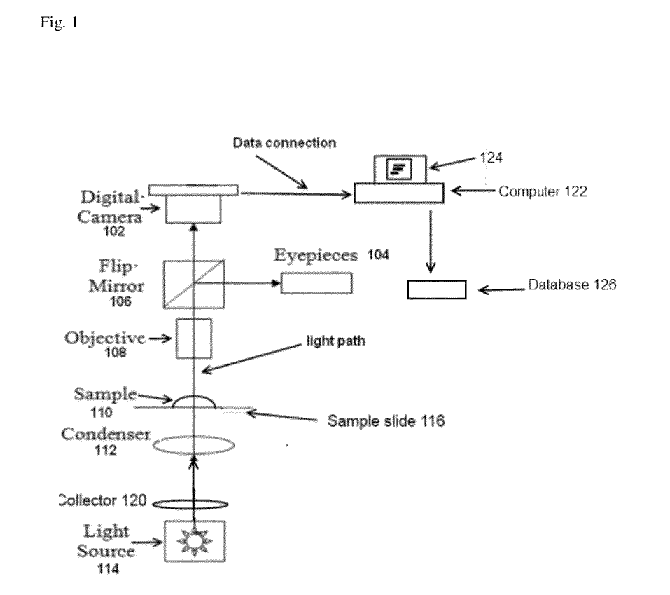

The principles behind the present invention are applicable to, and can be used in conjunction with, multiple types of microscopes. For example, the illustrated arrangement in FIG. 1 employs a transmission microscope. However, the present system and method are also applicable to reflectance microscopes. The image-calibration workflow system and method are operable with the above-referenced microscope types in either bright-field, dark-field or polarized configurations.

Furthermore, those skilled in the art will recognize that the principles behind the image-calibration workflow system and method can be used with additional microscope types not disclosed but whose operational principals are understood. Additionally, those skilled in the art will appreciate that the system and method so described can be applied to any microscope based image system, such as a whole slide scanner or similar imaging device.

The image-calibration workflow system is configured to apply color calibration to a collection of images, wherein this collection of images was obtained during a microscopy session. In one particular arrangement, the system is configured to allow the user to acquire images of a sample at a given microscope configuration, and then obtain an image of a calibration slide at the same configuration. The user is able to adjust the microscope and imaging device settings (such as those settings related to magnification and light-intensity) until they are comfortable with the image. The system is then configured to allow the user to obtain more images with the same specimen or a different specimen with the same microscope/imaging device settings.

After all the images, i.e. the sample images and at least one calibration slide image, taken at a particular microscope configuration and imaging device setting have been recorded, the user is free to alter the settings and record new images. Once the user changes the settings on the microscope and/or imaging device, an additional calibration slide image is required at the new, changed settings. All of the images are stored by the imaging device or processor of the present invention until such time as they are needed.

As such, the system of the present invention ensures that the calibration imaging step has the minimum impact on the quality of the image as well as the microscope session workflow.

However, in some instances, it is beneficial to change the objective (magnifications), light source intensity/color temperature and camera exposure of the microscope set-up in order to get the best image. (Increasing the light-source intensity is necessary to obtain enough light when the magnification is increased, and this light-intensity increase is accompanied by a color-temperature increase if the light source is halogen tungsten based.) In those situations, what is needed is a work flow procedure that allows the user to alter the objective or light intensity/color temperature of the microscope without needing to obtain a calibration slide image every time those settings are altered. Accordingly, for sample images acquired at a series of light intensities/color temperatures, a white-balance compensation step is introduced that color-compensates the sample images using only one calibration slide image.

Most of the commercially available microscope objective elements have small aberrations which allow for small light transmission efficiency variations across the different commercially available models. As such, the color captured from a microscope system is not overly dependent of the particular object element used to capture the image. In those instances when the highest color accuracy is not needed, the calibration slide for an image of a sample can be taken at one objective setting and this image can then be used to calibrate an image of the same sample taken at a different objective. In this arrangement, the same calibration matrix based on a calibration slide image taken under one objective can be applied on images taken with different objectives.

Similar to the objective, the light intensity/color temperature of microscopes is changed constantly by users in order to obtain the best desired image. The work flow procedure described is also configurable to compensate for the shifts in the intensity and color temperature during a series of image capture events.

One benefit of the white balanced work-flow is to eliminate the need for imaging the calibration slide repeatedly in the short term (such as when the light intensity changes). However, in order to successfully obtain an accurate color calibration matrix to be used in the color calibration process, a detailed calibration slide image is taken either at the first instance of a microscopy session, or as a periodic update to a previous calibration slide image.

White balancing the images, including the calibration slide image, frees the user to batch process, by color correction using the calibration slide, the images at a later date. For example, a centralized image processing system is configurable to calibrate different image batches so long as a calibration slide image is included in the batch to be processed. This calibration processing can be performed on or off-site using a different computer at a different location, such as at a remote office, or at an off-line image processing facility.

Separating the image capturing (microscope session) and the image processing (off-line processing session) not only allows a microscopist to focus on their job with the microscope without much worry about the color fidelity of the image, but also gives them a flexible work schedule to be able to process the images at another time and location.

The system for obtaining calibrated images can be more easily explained by reference to transmission microscope of FIG. 1. A transmission microscope is a device or apparatus in which the light source and the viewer are on opposite sides of the plane of the slide/specimen, and in which transmitted light is passed through the specimen. The light is transmitted to an eyepiece or image recording device designed to record images of the sample. When using a transmission microscope, those images are, for each spatial point, the product of the incident illumination of the light source and the transmittance spectrum of the specimen.

FIG. 1 illustrates an imaging device 102, e.g., a digital camera, configured to record images of a slide 116 in the transmission microscope. The light directed from the light source 114 is conditioned by a collector lens 120 and a condenser lens 112 and illuminates the sample 110 on the slide 116. The objective lens 108 collects the light (shown as a light path arrow) passing through the sample 110 and delivers that light to either the eyepiece 104 or imaging device 102, through a flip mirror 106. The imaging device 102 is configured to output the images to a processor, such as a computer 122. The computer 122 is optionally equipped with an output device 124, such as a calibrated monitor, or display device, and a database 126.

In the illustrated arrangement, the imaging device 102 may be a CCD (Charged Coupled Device) or CMOS (Complementary metal-oxide-semiconductor), having sufficient components to record images with sufficient resolution to a temporary or permanent storage device. In a specific arrangement, the CCD sensor of the imaging device 102 is a ⅓″ frame pixel recording device. In one arrangement, the imaging device is configured to record images having at least three (3) independent color channels (tri-chromatic characteristics).

The imaging device 102 is also configured to transmit recorded images to the computer 122 for analysis or processing. Those skilled in the art will appreciate that the data connection between the imaging device 102 and the computer 122, or any other device capable of communicating with the imaging device or computer, are selected from any standard wired or wireless connection. For example, the imaging device 102 and the computer 122 of FIG. 1 are connected via a data cable. However, in an alternative arrangement of elements, the data connection is supplied by a local area network (LAN) or short range wireless network using protocols such as Wi-Fi, Bluetooth, or RFID.

The imaging device 102 is any device capable of capturing the required spectral data in sufficient detail necessary for the calibration functions to proceed. For example, a digital still camera, digital motion picture camera, portable computer camera, desktop computer camera, FDA equipped with a camera, an imaging device of a smart-phone, a camera phone, a web camera, and so on, having sufficient resolution for capturing color information, are suitable imaging devices.

Additionally, the camera or imaging device is equipped to hold a temporary or live view image in a temporary memory. Furthermore, the camera or imaging device is configured to perform a white balance calibration on the live view image. In this way, the user is presented with the white balanced image prior to recording the white balanced image. The camera is further equipped with sufficient configurations, for example as an instruction set executing code of a processor integral to the imaging device, so as to allow the user to select an area to be used as the white reference for white balancing.

Those skilled in the art will recognize that any configurable device may be used as an imaging device so long as it is capable of capturing optical data through a lens or plurality of lenses, and transmitting an image file that includes the captured data and white balancing the image. As one non-limiting example, a digital single lens reflex camera and microscope adaptor form a suitable image capture device.

In one arrangement, the imaging device 102 is coupled to the microscope so as to record the microscope status at the time of the imaging. In this arrangement, the imaging device 102 is configurable so that each image file generated includes data describing the specific microscope and its configuration status.

In the given arrangement of FIG. 1, the light source 114 may be an incandescent light source, such as a halogen tungsten light source. In an alternative arrangement, the light source 114 is formed of multiple elements, each capable of providing a steady source of specific spectrum illumination, such as ultraviolet, infrared, daylight, tungsten light, fluorescent light, or other specific visible light spectra. Further, the light source 114 is positioned such that the reference illuminations emitted by the light sources 114 are incident upon the microscope stage and the slide 116 itself. In an alternative embodiment, these light sources are actively filtered so as to produce specific illumination characteristics.

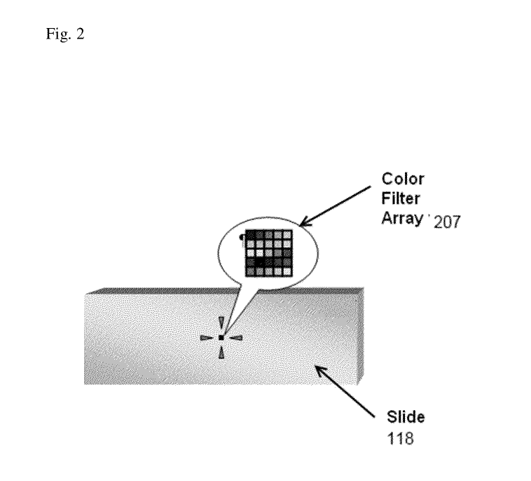

As seen in FIG. 2, a calibration slide 118 is also used in the present transmission microscope to generate the necessary color calibration matrix. In the illustrated arrangement the calibration slide 118 is a composite color filter array of known transmission spectra. The calibration slide, when introduced into the optical train, is positioned so that it is available to be directly illuminated by the light source. In one arrangement of the calibration slide 118, the included color filter array is a grid 207. However, those skilled in the art will appreciate that other specific geometries or other color calibration arrays are within the scope of the present invention.

In a further arrangement, the color filter array 207 of the calibration slide 118 contains a plurality of sections with different transmission spectra necessary to replicate the complete range of transmission spectra likely to appear in the slide image. In the preferred embodiment, at least one portion of the array contains achromatic (black, white and grey) elements. In a further preferred embodiment, the surfaces of the transmission calibration samples are substantially uniform across the surface of the sample. In this way, microscopic magnification of non-uniform surface features of the calibration samples is minimized. Thus, transmission microscope surfaces permit calibration samples with a greater degree of surface uniformity, and hence greater color precision. In one arrangement, the color filter array 207 contains a plurality of color elements with different transmission spectra that, when combined, provide a complete coverage of the visible spectrum. While the color filter array 207 is depicted within the center of the calibration slide 118, it is possible to position the color array at any position on the slide substrate that is visible to an imaging device 102 or manual reviewer observing the slide through the eyepiece 104.

In the described system, the specific transmission characteristics (such as transmission percentage at each wavelength for a variety of settings of the microscope numerical aperture) of each element of the color filter array is known and stored within database 126 accessible by the computer 122.

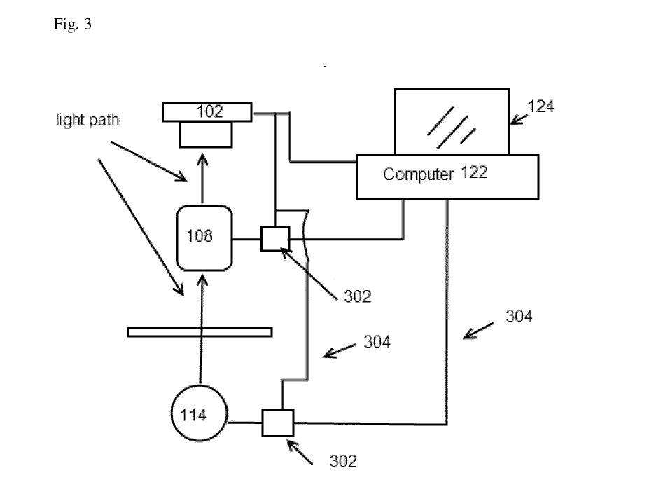

As illustrated in FIG. 3, elements of the microscope, such as the light source 114 and the lens objective 108 are configured with data acquisition devices 302 that enable them to bi-directionally communicate, e.g. through cables 304, their current status or state with the imaging device 102 and/or the computer 122.

In one arrangement, the microscope is configured with mechanisms (not shown) to automatically adjust the settings of the microscope, such as the light emitted by the light source or the numerical aperture of the objective 108. In the described arrangement actuators, relays, servo-motors, switches or other similar devices are used to change the operating configuration of the objective or the light source.

In one further arrangement, the settings of the microscope are adjustable by instructions sent from the computer 122. In yet a further arrangement, the values corresponding to the settings of the microscope components and imaging device are stored in a database 126. The database 126 is configured as a software program operating within the computer 122. In the alternative, the values corresponding to the settings of the imaging device and the microscope are stored in a separate setting storage device (not shown) that is configured to communicate with the computer and the microscope components.

The arrangements herein described are applicable to obtain either the greatest color consistency in the calibrated image or a simplified work flow using white balanced images to provide sufficiently accurate color calibration values for a color calibration procedure.

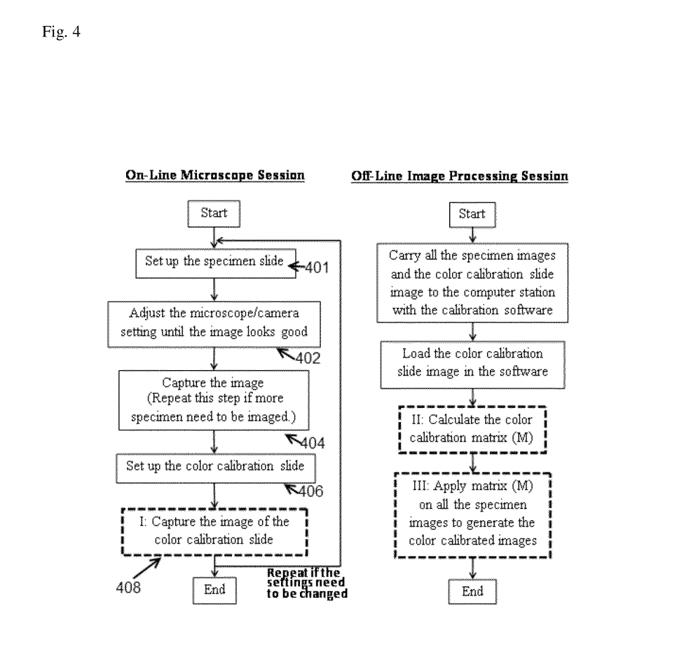

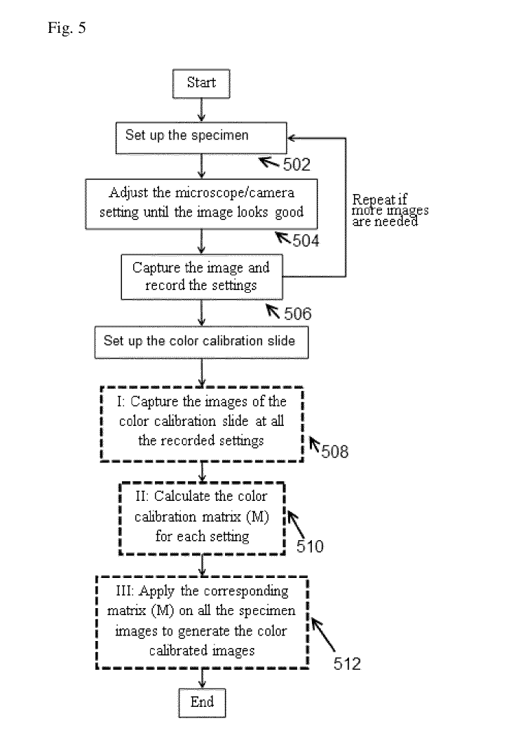

Those skilled in the art will understand that color consistency is the variation of the colors of the calibrated image and the sample image when there is a difference in microscope and camera settings. In situations where the minimum variation, i.e. best color consistency, is preferred for analysis, the work flow described in FIG. 4-5 provides a suitable work flow for obtaining minimal variance color consistency.

In a color consistency system, a user arranges, in steps 401-402, a slide in the microscope such that it can be imaged. In the described image-calibration workflow system, the user inputs or otherwise selects the appropriate microscope settings for recording a sample image, as in step 404. The user then obtains the image of the test sample and continues capturing more sample images, if desired, without changing the microscope and camera settings. So long as the settings of the imaging device or microscope are not altered, the user can insert additional specimen slides and obtain images of those slides. Typically, only a change in the characteristics of the specimens would require an adjustment of the imaging device or microscope.

Once all the test samples are captured at a given microscope setting, the system is then configured to record an image of the calibration slide without changing the microscope and/or camera settings, step 406. The system acquires an image of the calibration slide at the same microscope configuration, as in step 408. This procedure is repeated for each sample image captured at a different microscope or camera settings. Both the sample images and the calibration are off-loaded to the image processing session where instructions are executed to white balance each of the sample and calibration slide images, as in step 412-414. A color calibration matrix is calculated based on the calibration slide, as in step 416, and described more fully below. The color calibration matrix is applied to the sample images so as to produce calibrated final images, as in step 418. Similar steps for obtaining low color variance calibrations are apparent from the steps of 502-512 of FIG. 5, in which the calibration slide image is taken under all the microscope settings that have been recorded during this microscope session and the image processing is embedded in the camera software to calculate the color calibration matrices for all the recorded microscope settings and produce the calibrated images with the color calibration matrix generated with the same microscope settings

### White Balancing Using the Image Recording Appliance

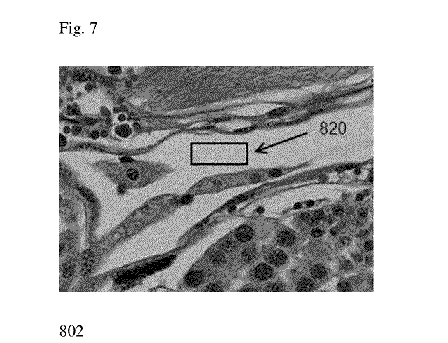

The arrangement described is modified by the inclusion of a white balancing step. As shown in FIG. 7, an open area selector 820 is used to identify an open area of an image of the sample which is suitable for calibration of white balance. In one arrangement, the open area selector 820 is manually placed on a desired location. In another arrangement, a histogram of the image is analyzed and a suitable open area is selected. In still a further arrangement, the area is automatically selected by an image processor based on pre-set or dynamically set criteria.

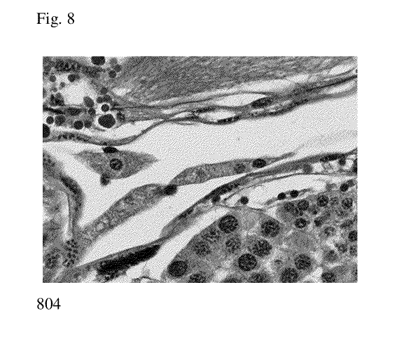

The sample image in FIG. 7 was analyzed using the work flow so described such that three (R, G, and B) adjustment factors, each corresponding to the ratio between the white value (235 for an 8-bit) and the reading value for the respective R, G, and B channels of the open area inside the open area selector was calculated. The three adjustment factors were then applied respectively to the R, G, and B channels of the entire image, generating a white balanced image in FIG. 8. As such, the variation of light source temperatures is compensated by the white balance of the captured images.

In some instances the camera exposure and/or the light intensity results in different image brightness values across different images of the same sample. This variation in brightness is corrected, in one arrangement, by scaling each image individually so that the selected open area 820 of each white balanced image has the same pre-defined RGB values. For instance, in an 8-bit image the RGB adjustment value is calculated to bring each channel to 235, while in a 16-bit image the adjustment value is used to bring each channel to 60160 or other values.

Once an image has been corrected with the above described white balance treatment, it can then be further processed by the color calibration matrix of the image processing appliance. That color-calibration matrix must be derived from a white-balanced color-calibration image.

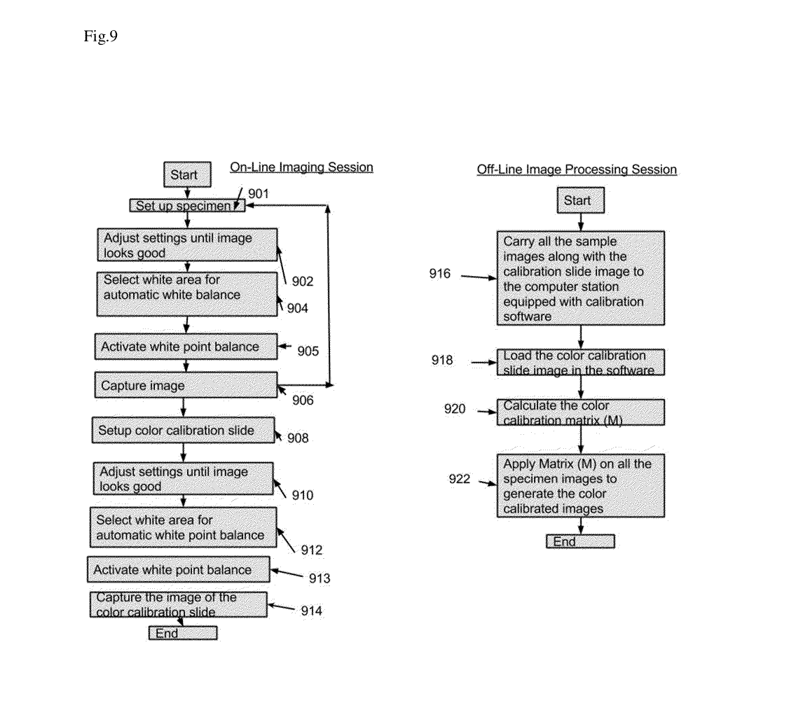

As shown in FIG. 9, a user arranges in step 901 the specimen in the slide such that it can be imaged by an imaging device. In this arrangement, the image recording portion of the system performs the white balance calculation.

In the described white balance image calibration workflow system, the user adjusts the live image from the image recording device until the user obtains the desired image scene as shown in step 902. Once the user has obtained the desired image scene, the user then selects a portion of the scene for white balancing as in step 904. Those skilled in the art will recognize that there several ways in which the white balancing might be selected or initiated by the user. Commercially available software or algorithms, or software incorporated into the firmware of the imaging device is configurable or selectable so as to allow a user to select an area for white balancing, as illustrated in FIG. 8, and described in step 904. Once the user has selected the desired location for white balancing, the imaging device is configured to automatically white balance the live or temporary image stored in the memory of the imaging device, as in steps 905. Once the image has been white balanced, the user is free to record the image and store the image in an image storage location as in step 906. In another arrangement, if an open area does not exist on the image to be white balance, a user would need to slightly move the sample around until an open area is available within the field of view and select that open area for white balancing. The user can move the sample back to the original location once the white balancing is done.

The user repeats steps 901-906, until all the images desired have been obtained. Once all the sample images have been captured, the system is then configured to record an image of the calibration slide. This set-up allows for the adjustment of the microscope and/or the imaging device as in step 908-910. The system acquires an image of the calibration slide at any microscope configuration that the user desires, and does not require a specific objective, exposure or intensity setting, as shown in step 910, as long as the entire color filter array is visible in the field of view. The user then selects an appropriate white area the calibration object or slide for the purposes of in-camera automatic white balancing as in step 912. Those skilled in the art will recognize that it is possible to provide for alternative methods and algorithms that employ non-white spaces in the image for calibration. Once the area is selected, the imaging device is configured to automatically white balance the live or temporary image stored in the memory of the imaging device, as in steps 913.

The image of the calibration slide is then recorded or saved as in step 914. Once the image of the calibration object or slide has been acquired, then both the sample images and the calibration slide image are off-loaded to the image processing session as in step 916. Those skilled in the art will appreciate that the order of acquisition of the calibration and sample images are changeable. The image processing appliance then executes instructions to calculate a color calibration Matrix (M) as in step 920 and apply this Matrix (M) to the specimen images to generate color calibrated images as in step 922.

The described work flow incorporates a step to white balance the sample or specimen images as well as the calibration slide image in order to compensate for the color shift induced by changing the light intensity during a microscopy session. In one exemplary arrangement, the images are white balanced by pixel-averaging the R, G, B values of an open space of the image. Since an open space is transparent to the substrate, it will, in this configuration be white. In a further configuration, the white balance step includes a sub-step of calculating three (3) adjustment factors (R, G, B) for all pixels which are able to bring the RGB values to a same value for white, such as 235 for an 8-bit image. The corresponding factor is applied to each pixel on the entire image, e.g. multiplication or another operation.

### White Balancing Using the Imaging Processing Appliance

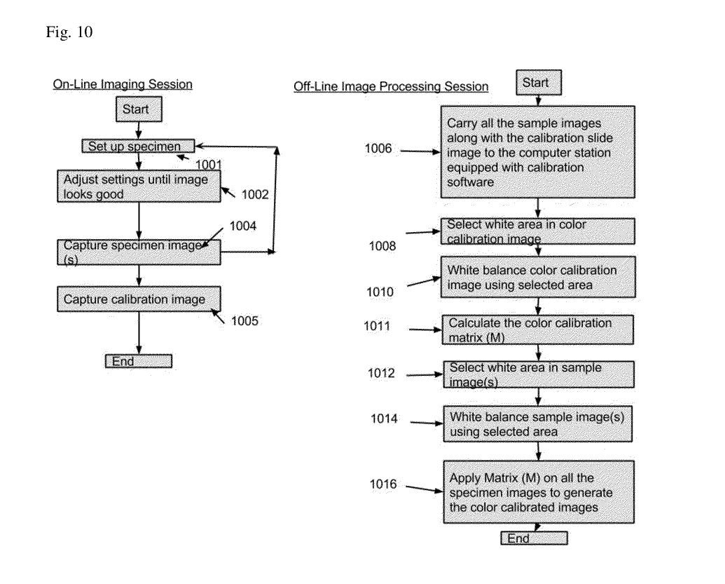

An alternative system is provided in FIG. 10. The illustrated system is adaptable to obtain sample and calibration slide images using the image acquisition appliance but without obtaining white balanced correction. In the foregoing arrangement, the sample images and color calibration slide image obtained during the imaging recording session are white balanced and this white balanced calibration slide image is used to generate a color calibration matrix M. In the foregoing, the white balancing procedures are conducted by the image processing system, and not the image capture system.

In the illustrated arrangement, the color calibration slide image is obtained in the same manner as in the workflow outlined in FIG. 9.

FIG. 10 illustrates an image processor based white-balance calibration system. As illustrated, a user arranges, in steps 1001-1004, a slide in the microscope such that it can be imaged. In the described white balance image calibration workflow system, the user inputs or otherwise selects the appropriate microscope settings for recording a sample image, as in the previously described work-flow systems (steps 1001-1004). Likewise, the user obtains an image of the color calibration slide or object, as in step 1005. Those skilled in the art will appreciate that the order of acquisition of the calibration and sample images are changeable.

In the illustrated process, all of the images acquired from the imaging device are loaded into an imaging processor appliance as in step 1006. Therefore, two white balance steps are performed. The first is a white balancing of the calibration slide image, as in step 1008-10. As in the previous system the user, or the image processor selects, an area of the image for white balancing 1008. The image processor executes an instruction set which automatically configures the white balance for the entire image based on the area selected by the user 1010. After this white balancing step, the color calibration Matrix is calculated as in step 1011. In this arrangement, the calibration procedure can be halted or returned to later, without needing to calibrate or apply the matrix to the samples. Once a user is ready to calibrate the sample images, a second white balancing step is preformed, as in step 1012-14. This white balancing is performed on each of the sample images to be calibrated. As with the calibration slide image, a first white balance step allows the user to select an area for use in the white balance calibration 1012. Once the white balance area has been selected, the processor automatically white balances the image step 1014.

Alternatively, a representative image can be used to set the proper parameters for a batch white balancing of all of the images based on the representative image. Once all the images have been white balanced, the Matrix (M) is applied to the specimen images to generate color calibrated images as in step 1016.

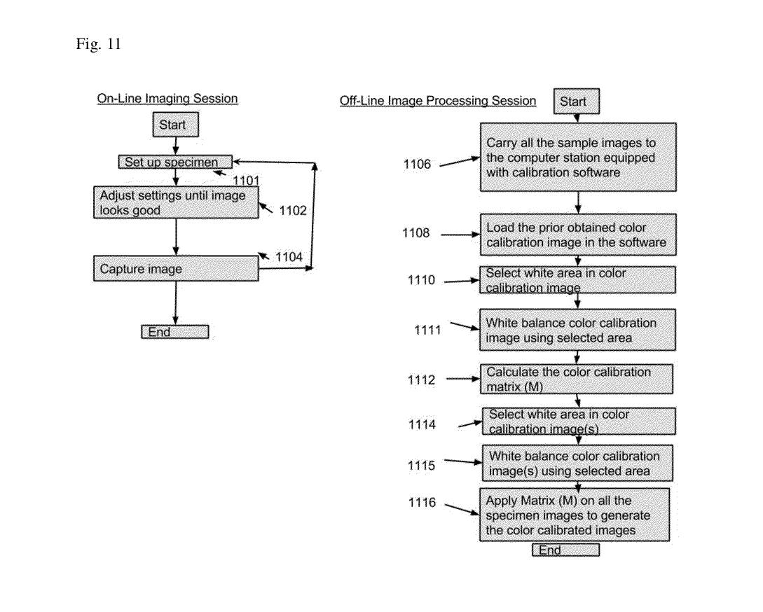

FIG. 11 illustrates an alternative example of a white-balance calibration work flow process. In the described process, a user arranges, in steps 1101-1104, a slide(s) on the microscope such that it can be imaged. In the described white balance image calibration workflow system, the user inputs or otherwise selects the appropriate settings for recording a sample image, as in the previously described work-flow systems. However, in this arrangement, no calibration slide image is acquired by the imaging device.

After all of the sample images are acquired, they are loaded into the calibration software as in step 1106. An image of a calibration slide which was captured previously is loaded in order to calculate the M matrix. Alternatively, the user can load the M matrix directly from an immediately prior calibration session. Alternatively, a user can select a desired calibration slide image from a database of calibration slide images depending on the user specified parameters, e.g. date, objective, exposure, color temperature. Furthermore, the system so described is configurable to automatically select a particular calibration slide image for use in any of the presented work flows based on user criteria, or an algorithm configured to determine the optimal calibration slide for a given set of sample images as in step 1108.

After the loading of the calibration slide, a two-stage white balance operator is performed on the loaded calibration slide image. In the first stage, the user, or the image processor, selects an area of the loaded calibration slide image for white balancing 1110. The image processor executes an instruction set which automatically configures the white balance for the entire image based on the area selected, as shown in step 1011. After this white balancing step, the color calibration Matrix is calculated as in step 1112. In this arrangement, the calibration procedure can be halted or returned to later, without needing to calibrate or apply the matrix to the samples. Once a user is ready to calibrate the sample images, a second white balancing step is preformed, as in step 1014-15. This white balancing is performed on each of the sample images to be calibrated. As with the calibration slide image, a first white balance step allows the user to select an area for use in the white balance calibration 1114. Once the white balance area has been selected, the processor automatically white balances the image step 1015. Once all the images have been white balanced, the Matrix (M) is applied to the specimen images to generate color calibrated images as in step 1116.

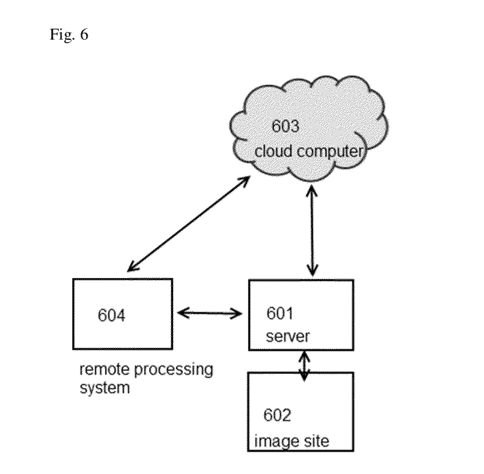

As an alternative embodiment of the present invention, it is possible to configure the calibration values of the color patches on the color calibration slide, such as the tristimulus values, for access by a remote processing computer system 604 or cloud based computer system 603 as illustrated in FIG. 6. For example, it is possible to transmit the calibration values from the imaging site computer 602 to a server 601 and on to a remote computer system 604 specially designed for image processing or to a cloud based distributed processing system 603. The local computer is further configured to possess a database 126 wherein reference transmission values are stored.

It is further expected that the local imaging system 601 is fully capable of connecting to external and internal networks so as to distribute processing tasks or exchange data imbedded within each slide. The computer system can connect to networks and databases using commonly understood programming interfaces and interface modules, e.g., Media Server Pro, Java, Mysql, Apache, Ruby on Rails, and other similar application programming interfaces and database management solutions. The remote analysis system 603 of the present invention is characterized, in part, by its broad adaptability to user configurations, multiple user inputs, and hardware configurations.

The remote analysis system 603 can also be accessed by way of a web portal, e-mail, or text message. The computing device is capable and configured to receive industry standard telecommunications for data transfer. Furthermore, the computing system is capable of parsing telephone, e-mail, and other header data so as to enable a return message to be sent to a user by means of conventional protocols as is commonly known (e.g., using the Automatic Number Identification (ANI) in a telephone call set-up, or sender address information in an email). The remote analysis system can be connected to in a conventional manner, such as by using a web browser program such as Mozilla's Firefox. The web portal offers the ability to transmit data from non-networked sources such as digital cameras, web camera, and digital tape feed.

The processor 122 is configured to process the sample images and the calibration slide images according to a sequence of instructions or steps that control the work-flow. For example, processor performs a spatial uniformity calibration on all the sample images and the color calibration slide images with the bright field image.

In one arrangement, the computer 122 is configured to calculate the normalized pixel values of an image. For example, wherein a bright-field arrangement is used, the pixel intensities of the bright field image are Iₒ(i,j,b), (Here, i, j denote the spatial position of a pixel and b denotes the spectral band within the camera.) For all the sample images and the color calibration slide image, the computer of the present system calculates the new pixel values, I(i,j,b), in one arrangement, by dividing the respective blank-field values Iₒ(i,j,b) to give the normalized pixels to be used in color calibration as described in the calibration matrix generation.

The system so described is configured, by software or other algorithms, executing code or instructions sets, to calculate the color calibration matrix using information obtained from the calibration slide and the settings of the imaging device and/or microscope. The computer 122 is configured by an instruction set, program or algorithm to generate a calibration matrix. Based on the microscope used to record the sample images, the computer 122 is configurable with a variety of color calibration matrix generation options. In one arrangement, the computer 122 is configured to allow a user to color calibrate the sample images based on a desired illumination spectrum which differs from the illumination spectrum that the sample image was taken under.

In particular, the computer 122 is configured to allow selection of a series of color correction options. For example, the computer 122 is configured to select one of a series of pre-defined destination illuminants for the resulting synthetic image. These destination illuminants (SPD vector), in part, configure the color values of the sample in the resulting synthetic image. For example, the destination illuminant selected is configured such that the resulting synthetic image matches the view of the sample as seen through the eyepiece of a microscope. In one example, the computer 122 provides access to a database 126 which stores various pre-determined SPD vectors. Each stored SPD vector corresponds to a particular known lighting condition.

In the event that the light source 114 SPD vector (corresponding to the destination illuminant) is not stored in the database 126, that SPD must be pre-measured by a spectro-radiometer such as is made by Konica-Minolta CS-1000a, coupled to the eye piece 104 of the microscope and configured to output the SPD vector for use in the present system.

In the described arrangement the user selects the desired color-correction mode (i.e., select a destination illumination spectrum according to whether the user wants the image to look like it would under a standard or pre-defined illuminant or to match the eyepiece image of the slide). If the user's goal is to match the slide's hypothetical appearance under a standard or pre-defined illuminant, or if the user does not a specify a specific match between the eyepiece image and the processed color image, the computer 122 is configured to load the SPD vector (S) as the CIE standard illuminant that is close to the light source being used in the microscope.

For example, if the light source is an incandescent halogen light, one can use illuminant A. If the light source is a LED, since there is no standard illuminant that matches LED spectrum, one can load the predefined LED spectrum based on the correlated color temperature (CCT) of the LED source. If the goal is to match the processed image to the eyepiece image and the microscope illuminant (measured at the eyepiece) is not close enough to any pre-defined spectrum, you must measure the actual SPD of the light source being used. The measurement can be done by a miniature spectrophotometer sitting behind the eyepiece position with the light entrance facing the light coming from the eyepiece(s). Alternatively, if the light source is incandescent, one can use a colorimeter rather than a spectrophotometer for measurement and estimate the spectrum from the measured tri-stimulus values assuming the incandescent light is a black-body radiator.

In particular, the computer is configured to generate a CIE tristimulus vector of each filter element incorporating the real or ideal illuminant spectral power distribution values, known color filter transmission spectra values, and the 2° CIE color matching functions into a 3-by-K matrix, where K is the number of filter elements and the dimension 3 represents the X, Y, Z tristimulus coordinates.

The computer 122 is further configured to accept images of the slide that incorporate pixels corresponding to the color filter array 107 and the pixels corresponding to the sample 110. The computer 122 is further configured to generate a matrix of all the RGB pixel values from each filter k, such that the RGB vector is

$${D}_{k} = {( \begin{matrix}R \\ G \\ B\end{matrix} )}_{k} ,$$

where k is the number of color filters. The 3-by-K R, G, B matrix (D) corresponds to the pixel color values of the filter array. This matrix is mapped to C.I.E. tristimulus value matrix ( X̅) through the use of a 3 by 3 color mapping matrix (M) using the equation X̅=MD. Following the least-square approximation, M is estimated as

M= X̅pinv(D)= X̅D′(DD′)⁻¹.

The database 126 is configured to store this color mapping matrix (M) for use with any subsequent test sample under the same illuminant with the same microscope settings.

Upon recording a raw image of the actual sample under study, the computer 122 transforms the raw image to generate device-independent C.I.E. tristimulus values of each pixel on the image such that the pixels are transformed according to the following the equation of

$${( \begin{matrix}X \\ Y \\ Z\end{matrix} )}_{i , j} = {M ( \begin{matrix}R \\ G \\ B\end{matrix} )}_{i , j}$$

where i and j are the pixel coordinate of the real sample image.

The computer 122 is configured to output these corrected images as either a device independent C.I.E. value image, or as an image of device-dependent RGB values for use with a color calibrated output device such as monitor 124. For example, the calibrated monitor is configured with a display profile that determines the proper display of RGB color values. The device independent C.I.E. value image is converted by sending the values through the proper display profile. Once converted through the display profile, the RGB values are properly configured for accurate display on the display device. Furthermore, a user is able to retrieve these images for further analysis or distribution.

The present invention also incorporates a sequence of steps for using the system so described to carry out and achieve the function of providing a color calibrated image to a display, e.g. display 124 or storing the color calibrated image in a database, e.g. database 126 for later retrieval. Such a method involves, but is not limited to an instrument selection step, in which the settings, such as N.A., light source intensity, light source CCT, objective, and camera white balance and exposure time/gain, are set to the desired levels before the color correction procedure.

The method includes a calibrating step in which a spatial uniformity calculation is performed on a blank microscope field. A calculating step is provided in order to determine the CIE tristimulus values of the plurality of color filters comprising the color filter array using a real or ideal illuminant spectral power distribution, the known transmission spectra, and the 2° CIE color matching functions. An image recording step is also provided, in which an image of the color filter array is recorded and sent to a computer for processing. The method also provides for an extracting step in which the computer extracts the corresponding camera-RGB pixel values of each color filter to a matrix and maps that matrix to the CIE tristimulus value matrix of the color filters. A transformation step is provided in which the computer extracts the corresponding camera-RGB pixel values for the entire sample image and converts those values into corresponding device independent C.I.E. tristimulus values using the color mapping matrix.

The method also includes a step of generating dependent RGB images for delivery to a calibrated monitor or printer. The present method also provides an optimization step for increased accuracy through the use of extended size matrices. In a further arrangement, the present method also includes an optional step of determining the spectral power distribution of the current illuminant through the use of a spectrophotometer or colorimeter.

Each of the steps described are performed and executed as a series of modules operating on a computer. Each of these modules can comprise hardware, code executing in a computer, or both, that configures a machine such as the computer 122 to implement the functionality described herein. The functionality of these modules can be combined or further separated, as understood by persons of ordinary skill in the art, in analogous implementations of embodiments of the invention.

The calibration module is further configured to include a series of sub modules for recording the microscope and digital imager settings, including the numerical aperture values, and image settings. Furthermore, a sub-module is provided for recording an image of a blank microscope field and storing the resulting pixels intensities as Iₒ(i,j,b). In this module, i, j denote the spatial position of a pixel and b denotes the spectral band within the digital imaging device. A normalizing sub-module is provided for dividing any subsequent image pixels Iₙ(i,j,b) by the respective blank-field values Iₒ(i,j,b) to generate a normalized pixel value for use in the color calibration or in color rendering modules.

The color selection step includes a sub-module for allowing a user to select a specific destination illumination of the resulting synthetic image. The destination illumination spectrum is determined according to the illumination spectrum desired for the synthetic image. The user may select a pre-defined illuminant to render the image, in which case the software retrieves one of the SPD vectors (S) for known or common illuminants that have been pre-stored in the database 126 accessible by the computer. Alternatively, the user may activate a sub-module configured to record the light-spectrum values from a spectroradiometer positioned in place of the eyepiece.

The calculating step includes a sub-module for obtaining the CIE tristimulus values of the color filters. In one particular instance, the instruction set uses specific algorithms to calculate the CIE-value vector

$$( \overline{{X}_{k}} = {( \begin{matrix}X \\ Y \\ Z\end{matrix} )}_{k} )$$

of each color filter by the following equations:

$$\begin{matrix}{X}_{k} = {k}_{0} {\sum }_{360 nm}^{780 nm} {T}_{NA} ( λ , k ) S ( λ ) \overline{x} ( λ ) Δ λ & ( Formula 1.0 ) \\ {Y}_{k} = {k}_{0} {\sum }_{360 nm}^{780 nm} {T}_{NA} ( λ , k ) S ( λ ) \overline{y} ( λ ) Δ λ & ( Formula 1.1 ) \\ {Z}_{k} = {k}_{0} {\sum }_{360 nm}^{780 nm} {T}_{NA} ( λ , k ) S ( λ ) \overline{z} ( λ ) Δ λ \\ With & ( Formula 1.2 ) \\ {k}_{0} = 100 / {\sum }_{360 nm}^{780 nm} S ( λ ) \overline{y} ( λ ) Δ λ & ( Formula 1.3 )\end{matrix}$$

Where T_{NA}(λ, k) is the transmission spectrum of the color filter at a specific numerical aperture (NA). The T_{NA}(λ, k) of each color filter is calibrated prior to the color correction and saved in a storage, such as a database 126 connected to the computer 122. S(λ) is the spectral power distribution (SPD) of either a standard illuminant, such as D65, A, and F11, or the actual SPD of the microscope light source.

In the above formulas, x(λ),y(λ),z(λ) are 2° CIE color matching functions, however any sufficient CIE formula is envisioned. The C.I.E. tristimulus values of all the color filters are combined into a 3 by K matrix ( X̅), where K is the number of color filters and 3 refers to the X, Y, Z values.

The calculating module also includes a sub-module for generating a matrix from the RGB pixel values of the color filter array such that a 3 by K matrix (D), where the k^{th} column of D

$$( {D}_{k} = {( \begin{matrix}R \\ G \\ B\end{matrix} )}_{k} )$$

represents the spatial average of the pixels from filter color k. An additional sub-module is provided to map the D matrix to C.I.E. tristimulus values ( X̅) matrix through a 3 by 3 color mapping matrix (M) using the equation X̅=MD. Following the least-square approximation, M is estimated as

M= X̅pinv(D)= X̅D′(DD′)⁻¹.

The optimization module also includes a sub-module for extending the linear 3 by 3 matrix to larger matrices in order to yield improved accuracy. In one example, the vectors Dₖ is extended from [R G B]ₖ′ to [R G B R² G² B² RG RB GB]ₖ′. As a result, the matrix D is extended from 3 by K to 9 by K, and the color mapping matrix (M) is extended from 3 by 3 to 3 by 9. This provides better color accuracy at the cost of less tolerance to the nonlinearity of the camera response. In the alternative, the sub module is equipped to extend the linear 3 by 3 matrix into larger matrices by extending vector Dₖ from [R G B]ₖ′ to [R G B (RG)^{1/2} (BG)^{1/2} (RB)^{1/2} . . . ]ₖ′.

An additional sub-module is directed to transforming the RGB values on each pixel of the sample image so as to match anticipated color values under the destination illuminant. For example, the transformation sub-module is configured to transform the pixels according to the following the equation

$${( \begin{matrix}X \\ Y \\ Z\end{matrix} )}_{i , j} = {M ( \begin{matrix}R \\ G \\ B\end{matrix} )}_{i , j}$$

where i and j are the pixel coordinate of the sample image. A further sub-module is provided to store the resulting XYZ C.I.E. tristimulus values in a database 126. Thus, the color calibration matrix M, derived from the tristimulus values of the array, is used to transform the RGB values of the image pixels of the test image to generate a device independent image. A display module is provided that processes the XYZ values through a display profile, thus creating a device-dependent image of the display-RGB inputs to drive a calibrated display device, such as monitor 124.

Once the imaging processing has been completed, the color corrected image can be sent to the calibrated display device, such as monitor 124 attached to local computer 122. The present invention can be configured so as to allow display devices, such as computer monitors and projection devices, to be calibrated through external calibration systems such as Spyder® calibration devices, or by using color information from the processed images themselves. In an alternative embodiment, the color corrected image is sent directly to a printer configured to accept the image file. In such an embodiment a monitor is not necessary. The printer can be any standard or customized printing device, in a standard state of calibration.

The present invention also incorporates a method for using the system so described to carry out and achieve the function of providing a color calibrated image to a display. Such a method involves, but is not limited to, a securing step, wherein the object or sample is affixed to a sample slide. The method also includes a recording step in which a plurality of images of the sample slide are recorded under a plurality of different lighting schemes and illuminations. A calibration selection step is also involved wherein the sample slide is removed from the microscope optical train and the microscope calibration slide is inserted into the optical train. A second recording step is then provided, wherein a plurality of images of the calibration slides are recorded. Each recording step provided is configurable, based on the microscope and the imaging device, to automatically generate the necessary settings of the microscope. In this way the system of the present invention is configurable to acquire the image(s) of the calibration slide under the plurality of lighting conditions without user action.

Next a calibration step is provided, wherein the poly-stimulus values of the images of the calibration slide are used to estimate the proper color and transmission values of each pixel of the sample slide images. For example, the calibration calculation processes as described in U.S. Ser. No. 13/211,875, are implemented with the described invention. Finally there is an output step wherein a calibrated image is generated with the proper color and is then provided in electronic file format ready for storage or transmittal to a display device.

The above processing functions can operate as a series of programmed steps performed by a properly configured computer system using one or more modules of computer-executable code. For instance, a set of software modules can be configured to cooperate with one another to provide accurate color reproduction information to a display device as described herein. In this regard, there can be an imaging module, a calibration setup and selection module, a data collection module, a calibration module, and an output module.

The imaging module can be configured as a series of discrete sub-modules designed to access optical data from a digital image capture device and convert that data into a format suitable for individual pixel analysis. The imaging module incorporates functions enabling the present invention to record a set number of images, change illuminants, configure recording resolution and alter built-in or other color filters.

A data collection module can be configured as a series of discrete sub-modules designed to access the microscope configuration states and the camera configuration states for each of the sample images and store that data in a database.

A calibration setup and selection module can be configured as a series of discrete sub-modules designed to access data from the data collection module and alter the settings on the microscope or imaging device to conform the settings to the values stored for a particular sequence of images.

The calibration module can be configured as a series of discrete sub-modules providing the present invention with the necessary functionality to white balance the image pixels, extract color value data from the image pixels, compare extracted color values against a database of reference color values, and transform the extracted pixel color values to conform to reference values.

The output module can be configured as a series of discrete sub-modules designed to provide functionality to the present invention. The discrete sub-modules could include instructions for combining the transformed pixels into a composite image, transmitting images to a display device, formatting images for a particular display device and updating a database of reference images and stored images.

Each of these modules can comprise hardware, code executing in a computer, or both, that configure a machine such as the computing system 601 to implement the functionality described herein. The functionality of these modules can be combined or further separated, as understood by persons of ordinary skill in the art, in analogous implementations of embodiments of the invention.

While the invention has been particularly shown and described with reference to a preferred embodiment thereof, it will be understood by those skilled in the art that various changes in form and details may be made therein without departing from the spirit and scope of the invention.

What is claimed:

1. A system for correcting the color of microscope images, comprising:
a microscope having:
an intensity-variable light source,
at least one microscope setting selector with a plurality of settings, and
a stage for receiving a sample slide securing a sample to be analyzed;
an image recording device having:
at least one image setting selector with a plurality of settings,
the imaging recording device configured to record at least one sample image of the sample slide;
wherein each image is comprised of a pixel array with each pixel having a color value, wherein each image is associated with the at least one microscope selector value at the time the image was taken;
at least one calibration slide image of the microscope calibration slide having an integral transmissive color filter array of known transmission spectra;
an image processor, executing code stored on a non-transitory medium therein, configured to color calibrate the sample images based on the calibration slide image;
wherein the pixels data of the at least one calibration and sample image have been transformed by a white balancing algorithm prior to color calibration of the at least one sample image by the image processor.

2. The system for correcting the color of microscope images of claim 1, wherein the processor is further configured to:
extract color value information from the pixel array of each of the plurality of images;
calculate the color calibration matrix based on the calibration slide image and the microscope setting value and image setting value,
transform the color value of each pixel of the sample image based on the calculated color calibration matrix, and
output a composite image wherein the color values of each pixel of the sample image have been transformed based on the color calibration matrix.

3. The system for correcting the color of microscope images as in claim 1, wherein at least one image of the color calibration slide is recorded by the image recording device.

4. The system for correcting the color of microscope images as in claim 1, wherein the image processor is configured to white balance the at least one sample and calibration slide images.

5. The system for correcting the color of microscope images as in claim 1, wherein the image recording device is configured to perform a real-time white balancing of a temporary image of at least one sample and calibration slide images held in the memory of the image recording device and record only an image of at least one sample and calibration slide images which have been white balanced.

6. The system for correcting the color of microscope images as in claim 4, wherein the at least one image of the color calibration slide is a pre-recorded image stored in a database accessible by the processor.

7. The system for correcting the color of microscope images as in claim 1, wherein the color temperature of the light source for at least one sample image is different than the color temperature of the light source for at least one other sample image.

8. The system for correcting the color of microscope images as in claim 1, wherein the color temperature of the light source for at least one sample image is different than the color temperature of the light source for at least one calibration slide image.

9. The system for correcting the color of microscope images as in claim 1, wherein the microscope selector value selected, and the image setting value selected at the time the image of the sample is obtained, are stored in a configuration database.

10. The system for correcting the color of microscope images as in claim 9, wherein the microscope and imaging device are configured to automatically change the microscope selector value and the imaging device setting value in response to a value stored in the configuration database.

11. The system for correcting the color of microscope images as in claim 1, wherein the color values of the integral color filter array of the calibration microscope slide are calculated from the known transmission spectra determined by the spectral power distribution of the destination illuminant and CIE color matching functions.

12. A method for managing the color on microscope images comprising:
setting at least one microscope image setting value and an image recording setting value, for a sample secured to a microscope slide in the microscope,
recording at least one image of a sample slide in the microscope with an image recorder;
obtaining at least one calibration slide image;
generating a white balanced image for at least one of the calibration slide image and sample image;
transforming, using a processor executing code, the color values of the sample image based on the color values of the calibration slide image.

13. The method for managing the color on microscope images of claim 12 further comprising;
extracting from the at least one calibration slide image a plurality of data points relating to color values of individual image pixels of the calibration slide;
generating from the plurality of calibration slide images a calibration matrix relating to color values of individual image pixels of the calibration slide;
transforming the pixels of the at least one sample slide with the calibration matrix; and
outputting the corrected image to a display device or storage medium.

14. The method for managing the color on microscope images of claim 12,
wherein the calibration slide image is obtained from a database or storage device.

15. The method for managing the color on microscope images of claim 12,
wherein the calibration slide image is recorded during a same imaging session as the sample images.

16. The method for managing the color on microscope images of claim 15,
white balancing all of the images prior to recording the images.

17. The method for managing the color on microscope images of claim 12,
white balancing, by code executing in the image processor device, all of the images.

18. The color calibration method of claim 13 including the steps of:
recording at least one microscope image setting value of the microscope when at least one sample image is recorded.
recording at least one imaging device setting value of the sample image when at least one sample image is recorded; and
automatically adjusting the imaging device settings and microscope settings such that a calibration slide image is recorded at each imaging device settings and microscope settings configuration that a sample image was taken.

19. A system for the color correction of images, comprising:
an image recording device having:
at least one image setting selector with a plurality of settings,
the imaging recording device configured to record at least one sample image of an sample object;
at least one calibration slide image of the calibration object, wherein the calibration object is configured with a transmissive color filter array of known transmission spectra, and
wherein each image is comprised of a pixel array with each pixel having a color value, wherein each image is associated with the at least one image selector value at the time the image was taken;
an intensity variable light source; and
an image processor, executing code stored on a non-transitory medium therein, to:
calibrate the color of the at least one sample image based on at least one calibration slide image;
wherein at least one of the sample image and at least one of the calibration slide image have undergone white balance correction prior to the color calibration.

20. The system for the color correction of claim 19, wherein the image processor is further configured to:
white balance at least one sample image and at least one calibration slide image.

21. The system for the color correction of claim 20, wherein the image recording device is further configured to:
white balance at least one sample image and at least one calibration slide image.
